(19) United States
(12) Patent Application Publication
(10) Pub. No.: US 2004/0249668 A1
(43) Pub. Date: Dec. 9, 2004

(54) Method and platform for real time digital transaction

(76) Inventors: Fadel Hachem, Paris (FR); Frederic Philibert, Acheres (FR); Florian Beaufume, Paris (FR)

Correspondence Address: YOUNG & THOMPSON, 745 SOUTH 23RD STREET, 2ND FLOOR, ARLINGTON, VA, 22202, US

(21) Appl. No.: 10/492,653

(22) PCT Filed: Oct. 16, 2002
(86) PCT No.: PCT/FR02/03541

(30) Foreign Application Priority Data
Oct. 18, 2001 (FR) 01/13445

(51) Int. Cl. G06F 17/60

(52) U.S. Cl. 705/2

(57) ABSTRACT

The invention concerns a method for real time digital transaction between a user terminal (3) and at least two targets (5a, 5b, 5c), comprising the following successive steps: a) receiving a message (M) emitted by the user terminal (3), b) carrying out a dialogue with the targets (5a, 5b, 5c) comprising a transmission of the message (M) to the targets (5a, 5b, 5c) and receiving replies (Ra, Rb, Rc) emitted by the targets (5a, 5b, 5c), c) transmitting at least one of the replies (Ra, Rb, Rc) to the user terminal (3). Said method is characterized in that the dialogue, during step b), comprises parallel execution of at least two elementary tasks assigned respectively to the dialogue with each of the targets.

The present invention relates to a method for real time digital transactions between a user terminal and at least two targets, the method comprising the following successive steps:

a) reception of a message sent by said user terminal,

b) dialog with said targets, including sending said message to said targets and receiving responses sent by said targets, and

c) transmission of at least one of said responses to said user terminal.

The invention also relates to a digital transaction platform for transactions between a user terminal and a plurality of targets.

A digital transaction platform, which is adapted to set up a transaction between a terminal and one or more targets, is useful to the user of the terminal who may use it to consult a large number of targets in a single operation, for example databases of companies selling a product the user is seeking.

A digital transaction platform is also useful to companies, who are contacted by users who might otherwise not have contacted them.

One nonlimiting example relates to the insurance market.

A user seeking to insure a car, for example, supplies to a platform information enabling the platform to consult a plurality of insurers.

The user may be a private person, an insurance broker, or a car dealer, for example. He may submit the request to the platform via Internet or Extranet sites or public XML interfaces, for example.

The consulted insurers send back quotations to the platform. The platform may sort them and then forwards them to the user's terminal.

Every digital transaction platform comprises hardware and software.

The hardware comprises a computer having an electrical power supply, electronic circuit cards (CPU, memory, graphics card, sound card, etc.) and a communication bus.

The hardware conventionally further comprises peripheral devices such as storage and archival storage means (readers for magnetic tapes, CD-ROMS, floppy disks, etc.), printers, and user interface means (screens, keyboards, mouses, etc.).

The software contains programs comprising instructions to the hardware. The programmed hardware may therefore provide calculation, communication, data storage, peripheral management, etc. means.

A digital transaction platform includes in particular one or more programs for driving the hardware in such a manner as to enable a digital transaction between a user terminal and target.

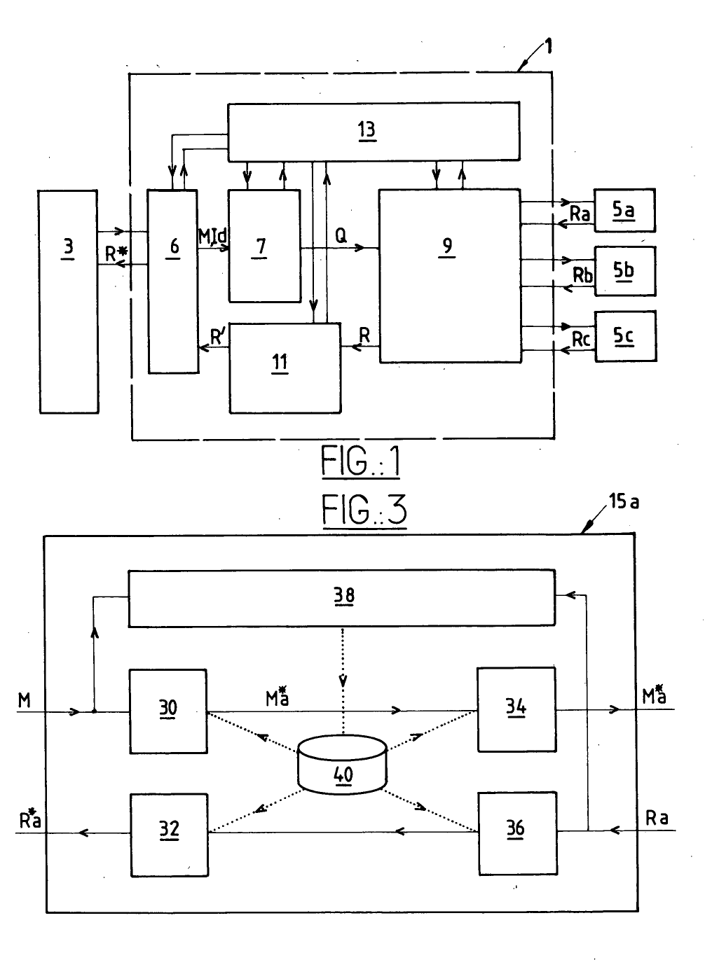

FIG. 1 is a diagram representing the functional architecture of a digital transaction platform 1, also referred to as a transactional platform.

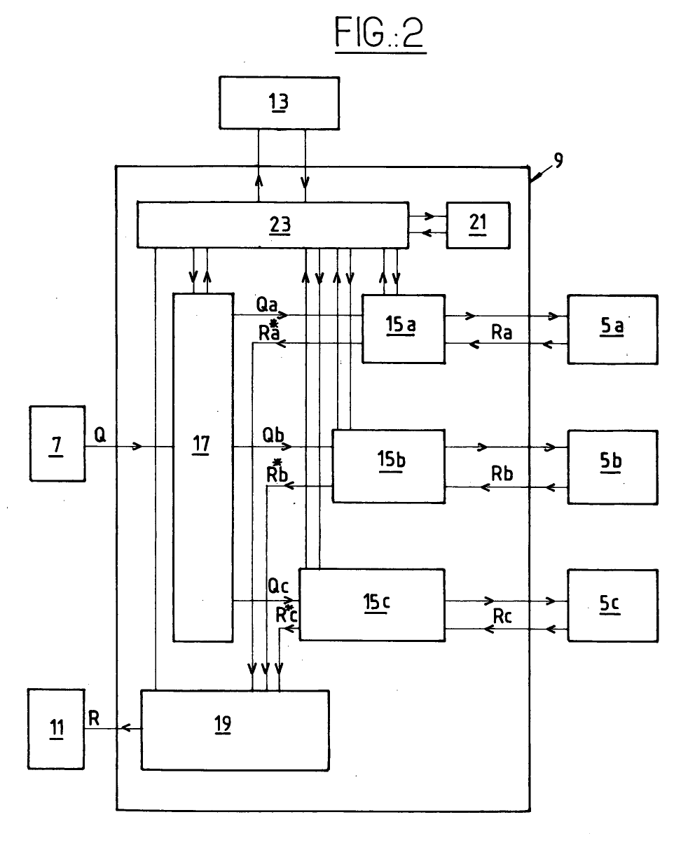

This functional architecture, like that shown in FIGS. 2 and 3 to be described hereinafter, comprises functional blocks each symbolizing a functional unit.

A functional unit comprises hardware and software, but is not necessarily coincident with a particular item of hardware and a particular program or program portion. For example, the same item of hardware or the same program may be used to execute functions of different functional units.

The digital transaction platform 1 is adapted to exchange digital information between a user terminal 3 and three targets 5a, 5b and 5c.

It comprises upstream interface means 6, routing means 7, downstream interface means 9, response processing means 11, and supervision means 13.

The user of the terminal 3 generally dialogs with the platform 1 by filling in a form displayed to him by the terminal 3 and enabling him to state his requirements.

The upstream interface means 6 are programmed to configure in real time the screen page read by the user.

For example, they may adapt the screen as a function of the identity of the user, using his graphics chart or inserting his logo. Similarly, if the user is an exclusive distributor of a make of vehicles, when he enters the type of vehicle to be insured the screen displays only vehicle types of that make.

The upstream interface means 6 also adapt the screen of the user terminal 3 as a function of the progress of the dialog. For example, they may fill in some fields in advance, adapt pages to responses previously given by the user, modify the number of pages, etc.

The user validates the form displayed to him by the upstream interface means 6 when he has finished filling it in. The upstream interface means 6 then prepare a message M containing at least the responses of the user to the fields of the form and transmit the message M to the routing means 7, for example with an identifier Id of the user.

The routing means 7 select from all possible targets those to which the message M should be sent. This selection may be conditioned by commercial agreements between an insurer and a vehicle distributor, for example.

The routing means 7 select potential targets without intervention by the user, for example as a function of the user's responses contained in the message M and/or his identifier Id.

The routing means 7 then generate a request Q containing at least the message M and means for identifying the targets 5a, 5b, 5c that they have selected. They then send the request Q to the downstream interface means 9.

The function of the downstream interface means 9 is to organize the dialog with the selected targets 5a, 5b, 5c and to deliver to the response processing means 11 a summary R of the respective responses Ra, Rb and Rc sent by the targets 5a, 5b and 5c.

The response processing means 11 are responsible for analyzing the responses supplied and processing them, for example by filtering them or by sorting them as a function of the amount of the quotations offered by the targets 5a, 5b and 5c and/or as a function of the user.

The response processing means 11 generate a result R′ and transmit it to the upstream interface means 6.

The upstream interface means 6 convert the result R′ to a form R* suitable for presentation to the user and then send R* to the user terminal 3.

The supervision means 13, informed at all times of all events occurring on the platform 1, supervise and organize the operation of the other means described above.

To interrogate the selected targets 5a, 5b, 5c, the downstream interface means 9 may, in a first configuration, consult data stored in a database common to all the insurers and regularly updated by them.

However, it is never certain, except immediately after updating the database, that the data consulted is up-to-date, and therefore that the response sent to the user is valid.

Moreover, it is necessary to know all the rules employed by insurers for offering a quotation. These rules may be complex and may change. Updating them is costly.

In a second configuration, to interrogate the selected targets, the downstream interface 9 may consult the targets themselves. The downstream interface means 9 then transmit the message to each of the selected targets in succession, advise the user of this, and inform the user that a response will be sent to him a few hours later, i.e. when all the targets consulted have analyzed the message and transmitted a quotation.

The response time may be long and the user must log on a first time to state his requirements and a second time to obtain the responses.

For the platform 1 to be able to deliver one or more responses quickly to the user, some platforms operate in real time, i.e. are able to supply a result R′ just a few seconds after the user has validated the form.

These platforms have downstream interface means 9 that interrogate each of the targets in succession, in real time, awaiting the response of one target before interrogating the next.

However, if a target does not respond, for example because it is down, the user terminal 3 does not receive a response. These platforms operating in real time are therefore not reliable.

The object of the invention is to provide a method of implementing a digital transaction platform for interrogating selected targets and transmitting a reliable result to the user terminal 3 in real time.

That object is achieved by means of a method for real time digital transactions between a user terminal and at least two targets, the method comprising the following successive steps:

a) reception of a message sent by said user terminal,

b) dialog with said targets, including sending said message to said targets and receiving responses sent by said targets, and

c) transmission of at least one of said responses to said user terminal.

This method is remarkable in that said dialog includes the parallel execution of at least two basic tasks respectively assigned to the dialog with each of said targets.

As the basic tasks are executed independently of each other, failure of any of them, in particular because the associated target is down, does not block the execution of the other basic tasks. Thus, despite the failure, a response is transmitted to the upstream interface means 6. The method according to the invention, implemented by the platform 1, therefore delivers a reliable result to the user terminal 3 in real time.

According to other features of the invention:

basic tasks are configured beforehand pending their assignment in real time to dialog with said targets;

said basic tasks are activated substantially simultaneously;

at least one of said basic tasks includes the selection of means for formatting said message and/or a response from said target associated with it and execution of said formatting;

at least one of said basic tasks includes selecting a connector adapted to the sending and/or receiving protocol with said associated target and the use of said connector;

said message and/or information coming from or going to said user terminal is formatted in an autodescriptive format;

said format is an XML type format;

said XML type format is an INSpM® format;

a basic task is interrupted after a particular time or after reception of a response from said associated target;

said basic task is returned to a waiting state immediately on said interruption.

The present invention also consists in a platform for real time digital transactions between a user terminal and at least two targets, for implementing a method according to the invention, the platform comprising:

upstream interface means with said user terminal adapted to produce a message expressing a request from a user and to transmit to said user terminal at least one response to said message from said targets,

downstream interface means adapted to transmit said message to said targets, to receive responses to said message from said targets, and to forward at least one of said responses to said upstream interface means, and

supervision means.

The digital transaction platform according to the invention is remarkable in that said downstream interface means comprise a plurality of transmission units adapted to operate independently of each other, each of said transmission units conducting a dialog with a respective one of said targets.

According to other features of the platform according to the invention

the platform comprises means for coordinating said transmission units so as to activate said transmission units substantially simultaneously;

the platform comprises a timer adapted to inform said coordination means of the expiry of a predetermined time-out starting on activation of said transmission units;

the platform comprises means for grouping said responses from said targets;

at least one of said transmission units comprises means for formatting said message and/or a response from a target assigned to said transmission unit;

the platform comprises means for selecting said formatting means;

at least one of said transmission units comprises a connector adapted to the sending and/or receiving protocol for a target assigned to said transmission unit;

the platform comprises means for selecting said connector;

the platform comprises routing means adapted to select said targets and to produce a request containing at least said message and information on the communication protocols used by said targets;

the platform comprises means for processing responses from said targets;

said message and/or information in transit between said upstream interface means and said user terminal is formatted in an autodescriptive format;

said format is an XML type format;

said format is an INSpM® format;

said supervision means are adapted to assign preconfigured dialog tasks to at least one of said transmission units.

Other features and advantages of the present invention will become apparent on reading the following description and from the accompanying drawings, in which:

FIG. 1 is a diagram representing the general functional architecture of a digital transaction platform;

FIG. 2 is a diagram representing the functional architecture of downstream interface means of a preferred embodiment of a digital transaction platform according to the invention; and

FIG. 3 is a diagram representing the functional architecture of a transmission unit of a preferred embodiment of a digital transaction platform according to the invention.

Identical reference numbers are used in FIGS. 1, 2 and 3 to designate identical units.

The platform according to the invention has a general functional architecture of the type represented in FIG. 1 and described in the preamble.

According to the invention, the upstream interface means 6 advantageously send to the routing means 7 and receive from the response processing means 11 messages formatted in an autodescriptive format, i.e. a format including means for identifying the nature of the information that it contains.

That format is preferably an XML type format. In this format, each item of information is inserted between tags that specify its nature. The tags are preferably comprehensible to the user, which facilitates interpreting the message.

In the insurance field, the format is preferably the INSpML® format. The INSpM® format is a derivative of the XML format in which the tags are adapted to the data used in the insurance field.

According to the invention, the downstream interface means 9 represented in FIG. 2 comprise three transmission units 15a, 15b and 15c that dialogue with the targets 5a, 5b and 5c, respectively, and with distribution means 17 and grouping means 19.

The downstream interface means 9 further comprise a timer 21 and coordination means 23.

The platform 1 according to the invention advantageously further comprises a pool, not shown, of preconfigured basic tasks. A task is configured when it has been prepared for rapid execution by a transmission unit.

Informed by the routing means 7 of the selected targets, the supervision means 13 extract configured basic tasks from the pool and assign them to the transmission units associated with or assigned to those targets.

A basic task assigned to a transmission unit enables the transmission unit to communicate with the target with which it is associated. The activation of a configured basic task may advantageously follow very closely its assignment to a target.

A request Q from the routing means 7 reaches the distribution means 17. It includes the message M containing the information supplied by the user when he fills in the form, together with protocol information relating to the targets selected by the routing means 7. The protocol information includes, for each selected target, the type of protocol to be used to connect to the target, for example JMS, HTTP, HTTPS, and protocol data specific to that target and needed for setting the parameters of that type of protocol, for example its IP address, the HTTP service port to be contacted, the name of the HTTP variables for sending parameters, the version of the HTTP protocol used, the name of the JMS queue, etc.

The protocol information may be stored in a targets-protocols table, not shown, supplying the corresponding protocol information for each target.

The distribution means 17 convert the request Q into three basic requests Qa, Qb and Qc addressed to the three targets 5a, 5b and 5c, respectively. The basic request addressed to a target contains a copy of the message M and the protocol information relating to that target.

The distribution means 17 send the basic requests Qa, Qb and Qc to the three transmission units 15a, 15b and 15c, respectively, assigned to the three selected targets 5a, 5b and 5c, respectively.

The coordination means 23 then start the timer 21 and simultaneously activate the transmission units 15a, 15b and 15c, i.e. start execution of their respective basic tasks.

As will emerge in more detail in the remainder of the description (FIG. 3), the transmission units 15a, 15b and 15c communicate with their respective targets 5a, 5b and 5c. As soon as a response is received from a target, a transmission unit transmits it to the grouping means 19, where applicable after conversion, as described in more detail hereinafter.

Ra*, Rb* and Rc* designate the responses transmitted to the grouping means 19 by the transmission units 15a, 15b and 15c, respectively.

When the three responses Ra*, Rb* and Rc* have reached the grouping means 19, the latter group them and forward them to the response processing means 11 in the form of a summary R.

The chronological sequence of operations executed by the platform 1 is similar to that described previously with reference to FIG. 1.

According to the invention, the coordination means 23 check that all the responses from the targets 5a, 5b and 5c have reached the grouping means 19 before the expiry of a predetermined time-out starting from the activation of the transmission units 15a, 15b and 15c and counted by the timer 21.

If the time-out occurs before all the transmission units 15a, 15b and 15c have transmitted a response, the coordination means 23 instruct the grouping means 19 to use the responses that they already have and thus to send only those responses to the response processing unit 11.

A transmission unit is advantageously deactivated, that is to say its basic task is advantageously interrupted, immediately after sending a response to the grouping means 19 or, if it has not done so before the time-out, immediately after the time-out. The basic task is immediately returned to the pool so as to be available to respond to a new request. The number of basic tasks to be configured and maintained in the pool is therefore limited. This economizes on resources.

A transmission unit according to the invention, for example the transmission unit 15a represented in FIG. 3, has upstream and downstream formatting means 30 and 32, respectively, upstream and downstream connectors 34 and 36, respectively, selection means 38, formatting means 30 and 32, and connectors 34 and 36.

As will emerge in more detail hereinafter, the transmission unit 15a looks up information in a database 40.

After it has been assigned to dialog with the target 5a, the transmission unit 15a receives a copy of the message M and the protocol information relating to the target 5a.

The format of the message M, i.e. the manner in which the information from the form is coded, may be compatible with the format expected by the target 5a. If not, the format must be modified.

On receiving the message M, preferably in the XML or INSpM® format, the selection means 38 of the transmission unit 15a according to the invention look in the database 40 to determine if formatting means, also referred to as conversion means, are provided for the messages addressed to the target 5a.

An XSL file containing the information necessary for converting the message M may be provided, for example. In this case, the transmission unit 15a transmits to a converter, not shown, at least the XSL file and the message M. After converting the message M by means of the XSL file, the converter returns a message Ma* formatted in such a way as to be comprehensible to the target 5a. In this example the XSL file and the converter constitute said upstream formatting means 30.

The selection means 38 of the transmission unit 15a according to the invention also look up in the database 40 an upstream connector 34 adapted to the type of protocol used by the target 5a. They set the parameters of the upstream connector 34 by means of protocol data specific to the target 5a.

The message M may then be transferred in a format and in accordance with a protocol comprehensible to the target 5a.

In the same fashion, the selection means 38 select and set the parameters of the downstream connector 36 and the downstream formatting means 32, so as to be able to receive the response Ra from the target 5a, and forward a converted response Ra* in a format comprehensible to the grouping means 19.

The platform 1 according to the invention is advantageously able to adapt very easily to new communication protocols or to new formats used by the targets.

To adapt to a new format used by a target, it suffices to create the corresponding XSL file. This is because the converter is a standard unit and adapts its action as a function of the content of the file. It therefore has no need to be reprogrammed.

In the event of a new protocol to be used for a target, it suffices to add the corresponding new connector into the database 40 and to update the targets-protocols table containing the information on the protocol used by each target, i.e. the type of protocol and the protocol data of that target.

The platform 1 according to the invention therefore adapts particularly easily to the addition of potential new targets.

One objective of the platform 1 is to consult a large number of targets. The number of targets connected to the platform 1 is therefore liable to change. The possibility of adding supplementary targets without new programming of the downstream interface means 9 thus limits the costs associated with such additions.

Of course, the present invention is not limited to the embodiment described and shown, which is provided by way of illustrative and non-limiting example.

In particular, the number of transmission units is not limited to three.

Furthermore, the portion of the response R* sent to the user terminal 3 and corresponding to a response, for example Ra, from a target may differ significantly from that response Ra, not only in terms of its format but also in terms of its content. For example, the conversions applied to the response Ra before it reaches the user terminal 3 may include modification of the content of the response Ra, for example filtering out some of its elements. The result of these conversions is regarded as still constituting a response from the target, even if it is merely a portion or conversion of the response actually sent by the target.

The invention is not limited to the mode of operation described. For example, information other than that described may pass through the platform 1.

1. A method for real time digital transactions between a user terminal (3) and at least two targets (5a, 5b, 5c), the method comprising the following successive steps:
a) reception by a platform (1) of a message (M) sent by said user terminal (3),
b) dialog of said platform (1) with said targets (5a, 5b, 5c), including sending said message (m) to said targets (5a, 5b, 5c) and receiving responses (ra, rb, rc) sent by said targets (5a, 5b, 5c), and c) transmission of at least one of said responses (ra, rb, rc) by said platform (1) to said user terminal (3), which method is characterized in that said dialog includes the parallel execution of at least two basic tasks respectively assigned to the dialog with each of said targets (5a, 5b, 5c).

2. Method according to claim 1, characterized in that basic tasks are configured beforehand pending their assignment in real time to dialog with said targets (5a, 5b, 5c).

3. Method according to either claim 1 or claim 2, characterized in that said basic tasks are activated substantially simultaneously.

4. Method according to any preceding claims, characterized in that at least one of said basic tasks includes the selection of means (30, 32) for formatting said message (M) and/or a response (Ra) from said target (5a) associated with it and execution of said formatting.

5. Method according to any preceding claims, characterized in that at least one of said basic tasks includes selecting a connector (34, 36) adapted to the sending and/or receiving protocol with said associated target (5a) and the use of said connector (34, 36).

6. Method according to any preceding claims, characterized in that said message (M) and/or information coming from or going to said user terminal (3) is formatted in an autodescriptive format.

7. Method according to claim 6, characterized in that said format is an XML type format.

8. Method according to claim 7, characterized in that said XML format is an INSpML® format.

9. Method according to any preceding claim, characterized in that a basic task is interrupted after a particular time or after reception of a response (Ra, Rb, Rc) from said associated target (5a, 5b, 5c).

10. Method according to claim 9, characterized in that said basic task is returned to a waiting state immediately on said interruption.

11. Method according to any preceding claims, characterized in that said platform selects said targets (5a, 5b, 5c) without intervention of a user of said user terminal (3).

12. Method according to claim 11, characterized in that said platform selects said targets (5a, 5b, 5c) according to responses of said user contained in said message (M).

13. Method according to either claim 11 or claim 12, characterized in that said platform (1) selects said targets as a function of an identifier (Id).

14. Platform for real time digital transactions between a user terminal (3) and at least two targets (5a, 5b, 5c), for implementing a method according to claim 1, the platform comprising:
upstream interface means (6) with said user terminal (3) adapted to produce a message (M) expressing a request from a user and to transmit to said user terminal (3) at least one response to said message (M) from said targets (5a, 5b, 5c),
downstream interface means (9) adapted to transmit said message (M) to said targets (5a, 5b, 5c), to receive responses (Ra, Rb, Rc) to said message (M) from said targets (5a, 5b, 5c), and to forward at least one of said responses to said upstream interface means (6), and
supervision means (13), which platform is characterized in that said downstream interface means (9) comprise a plurality of transmission units (15a, 15b, 15c) adapted to operate independently of each other, each of said transmission units (15a, 15b, 15c) conducting a dialog with a respective one of said targets (5a, 5b, 5c).

15. Platform according to claim 14, characterized in that it comprises means (23) for coordinating said transmission units (15a, 15b, 15c) so as to activate said transmission units (15a, 15b, 15c) substantially simultaneously.

16. Platform according to claim 15, characterized in that it comprises a timer (21) adapted to inform said coordination means (23) of the expiry of a predetermined time-out starting on activation of said transmission units (15a, 15b, 15c).

17. Platform according to any of claims 14 to 16, characterized in that it comprises means (19) for grouping said responses (Ra, Rb, Rc) from said targets (5a, 5b, 5c).

18. Platform according to any of claims 14 to 17, characterized in that at least one of said transmission units (15a, 15b, 15c) comprises means (30, 32) for formatting said message (M) and/or a response (Ra, Rb, Rc) from a target (5a, 5b, 5c) assigned to said transmission unit (15a, 15b, 15c).

19. Platform according to claim 18, characterized in that it comprises means (38) for selecting said formatting means (30, 32).

20. Platform according to any of claims 14 to 19, characterized in that at least one of said transmission units (15a, 15b, 15c) comprises a connector (34, 36) adapted to the sending and/or receiving protocol for a target assigned to said transmission unit (15a, 15b, 15c).

21. Platform according to claim 20, characterized in that it comprises means (38) for selecting said connector (34, 36).

22. Platform according to any of claims 14 to 21, characterized in that it comprises routing means (7) adapted to select said targets (5a, 5b, 5c) and to produce a request (Q) containing at least said message (M) and information on the communication protocols used by said targets (5a, 5b, 5c).

23. Platform according to any of claims 14 to 22, characterized in that it comprises means for processing responses (11) from said targets (5a, 5b, 5c).

24. Platform according to any of claims 14 to 23, characterized in that said message (M) and/or information in transit between said upstream interface means (6) and said user terminal (3) is formatted in an autodescriptive format.

25. Platform according to claim 24, characterized in that said format is an XML type format.

26. Platform according to claim 25, characterized in that said format is an INSpM® format.

27. Platform according to any of claims 14 to 26, characterized in that said supervision means (13) are adapted to assign preconfigured dialog tasks to at least one of said transmission units (15a, 15b, 15c).
